(19) United States
(12) Patent Application Publication
(10) Pub. No.: US 2001/0012149 A1
(43) Pub. Date: Aug. 9, 2001

(54) OPTICAL ELEMENTS COMPRISING PHOTONIC CRYSTALS AND APPLICATIONS THEREOF

(76) Inventors: SHAWN-YU LIN, ALBUQUERQUE, NM (US); VINCENT M. HIETALA, PLACITAS, NM (US); ERIC D. JONES, EDGEWOOD, NM (US)

Correspondence Address: SANDIA NATIONAL LABORATORIES, PATENT & LICENSING CENTER, P O BOX 5800 MS 0161, ALBUQUERQUE, NM, 871850161

(21) Appl. No.: 08/960,930

(22) Filed: Oct. 30, 1997

(51) Int. Cl. H01S 3/00

(52) U.S. Cl. 359/344

(57) ABSTRACT

The present invention describes the use of photonic crystals to form optical elements which function in optical apparatus in frequency ranges outside photonic band-gaps. Such optical elements may apply such optical properties as dispersion, anisotropy, and birefringence (all of which are exhibited by photonic crystals outside photonic band-gaps). A variety of optical apparatus, including spectrometers, radiation sources, and lasers are enabled by such optical elements.

This invention was made with Government support under Contract DE-AC04-94DP85000 awarded by the U.S. Department of Energy. The Government has certain rights in the invention.

### BACKGROUND

The present invention relates generally to the application of photonic crystals in the design of optical elements, and more particularly to the design and production of optically transparent elements, e.g., prisms, suitable for use with electromagnetic radiation having wavelengths ranging from microwave (^{˜}30 cm) to ultraviolet (^{˜}30 nm).

A photonic crystal is a periodic dielectric array in which the propagation of electromagnetic waves is influenced by interference as the electromagnetic waves scatter from the periodic array. It is convenient to use the language of solid-state band structure to describe the overall (or macroscopic) optical properties of a photonic crystal.

A periodic array exhibits discrete translational symmetry. That is, the array appears invariant under translations which are an integral multiple of some fixed fundamental symmetry vector or vectors which are characteristic of the array. If an array exhibits more than one discrete translational symmetry having nondegenerate fundamental symmetry vectors such that all such vectors are coplanar, we shall describe the overall structure as an two-dimensional photonic crystal, otherwise it is a three-dimensional photonic crystal.

Electronic band structure is determined by the periodic distribution of nuclear charges which make up the crystal lattice. If the potential produced by these charges is strong enough, gaps can be introduced into the energy band structure of the crystal—gaps corresponding to a range of energies for which propagation of electrons is forbidden. Such propagation is forbidden because the wavefunction of an electron having an energy within the bandgap is subject to destructive interference through interaction with the periodic crystal structure.

Analogous effects are seen in photonic crystals, where electrons are replaced by electromagnetic waves and the periodic potential of the crystal lattice is replaced by a sufficiently large periodic variation in the microscopic dielectric constant of the material. (We define microscopic properties of a photonic crystal to be the bulk properties of the material making up the photonic crystal. Macroscopic properties are the properties of the photonic crystal taken as a whole.) Note also that photonic crystals may be constructed of a periodic array of low-loss reflective elements, or equivalently of elements whose dielectric constant is large enough (e.g., KTaNbO₃, whose dielectric constant is about 34000) that the elements are nearly perfect reflectors when surrounded by conventional materials.

One can design and construct photonic crystals having photonic band gaps. Light having frequencies within the photonic bandgap cannot propagate in such materials, resulting in complete reflection of such light from the material. [A complete description of the band-gap phenomenon requires that polarization and propagation direction of the photons relative to the photonic crystal be taken into account. A useful source for the theory underlying photonic crystals is Photonic Crystals (Princeton University Press, Princeton, N.J., ISBN 0-691-03744-2, 1995) by Joannopoulos, Meade and Winn, included herein by reference.]

To have a band-gap in frequency requires that two modes with identical wavevectors have different energy. (Recall that photons obey E=hf, where E is the photon energy, f is the photon frequency, and h is Planck's constant.) Light can reduce its energy in photonic crystals by concentrating the displacement vector in regions of high dielectric constant. This effect breaks the degeneracy between two sets of modes which are allowed by the lattice symmetry, in a manner similar to the separation of acoustic and optical phonons in a lattice having more than one atom per unit cell.

In one set of modes, called dielectric modes, the displacement field associated with the light is concentrated in high dielectric constant regions of the photonic crystal, thereby producing a low energy for a given wavevector. These are analogous to acoustic phonons. In the other set, called air modes, the displacement field is concentrated in regions of low dielectric constant, producing a higher energy for the same wavevector. If this difference in energies is sufficiently large, a complete photonic band-gap (i.e., a range of frequencies in which no light can propagate, regardless of propagation direction or polarization orientation) can result.

Little attention has previously been paid to the optical properties of a photonic lattice for wavelengths which can propagate through the material. Indeed, all known prior art optical elements comprising photonic crystals, such as mirrors, optical cavities, waveguides, and the like, function within a complete photonic bandgap and are based on the exclusion of such light from the photonic crystal. In contrast, the previously unexploited transmissive optical properties of photonic crystals form the basis for the present invention.

The present invention encompasses the use of photonic crystals as transmissive elements in optical apparatus. As a specific example, using such materials to form prisms having useful dispersion in a desired region of optical wavelengths is disclosed. Other optical elements can be formed in analogous manner. For the purposes of this application, an optical element may be a single piece of optics, or may be a subsystem comprising more than one piece of optics. Various embodiments and other features, aspects, and advantages of the present invention will become better understood with reference to the following description and appended claims.

### SUMMARY

The present application is directed to optical elements comprising photonic crystals and which are functional in spectral ranges for which propagation in the photonic crystal is not prohibited by a photonic band-gap. Such optical elements may be two or three-dimensional in nature, may utilize dispersion, birefringence, or other optical properties resulting from the design of the photonic crystal, and may be comprised in optical apparatus including spectrometers and radiation sources. The present invention will be illustrated by numerous specific implementations. The scope of the invention, however, is not intended to be limited by presenting these implementations, but only by the detailed claims below.

### BRIEF DESCRIPTION OF THE ILLUSTRATIONS

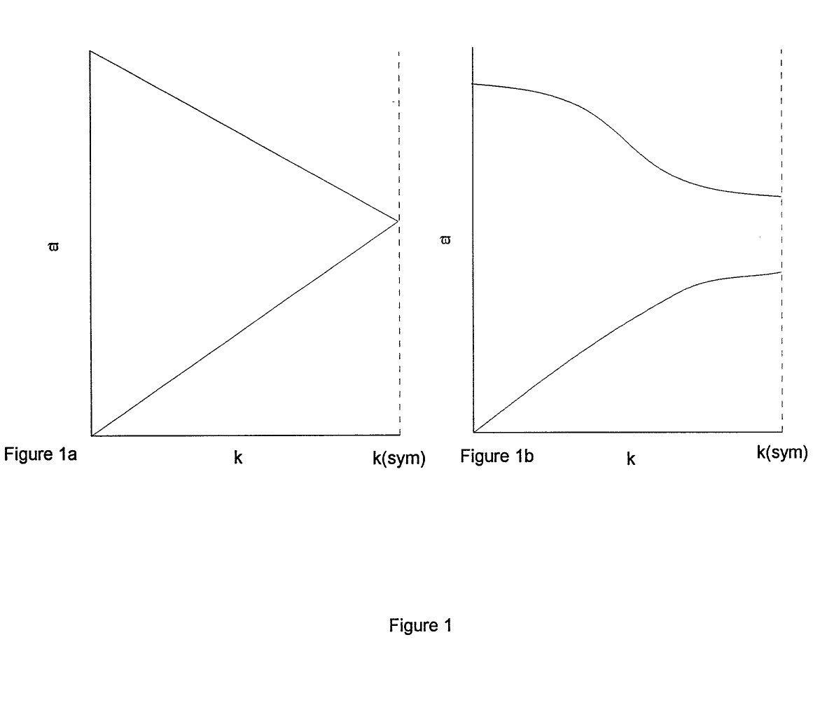

FIG. 1 shows schematic photonic band structures for FIG. 1a) a uniform optical material and FIG. 1b) a photonic crystal.

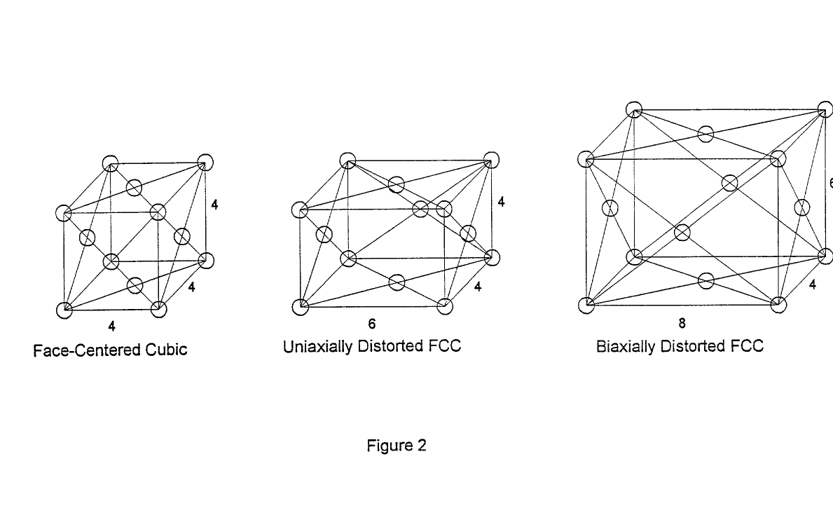

FIG. 2 shows the face-centered cubic symmetry and uniaxial and biaxial distortions of that symmetry.

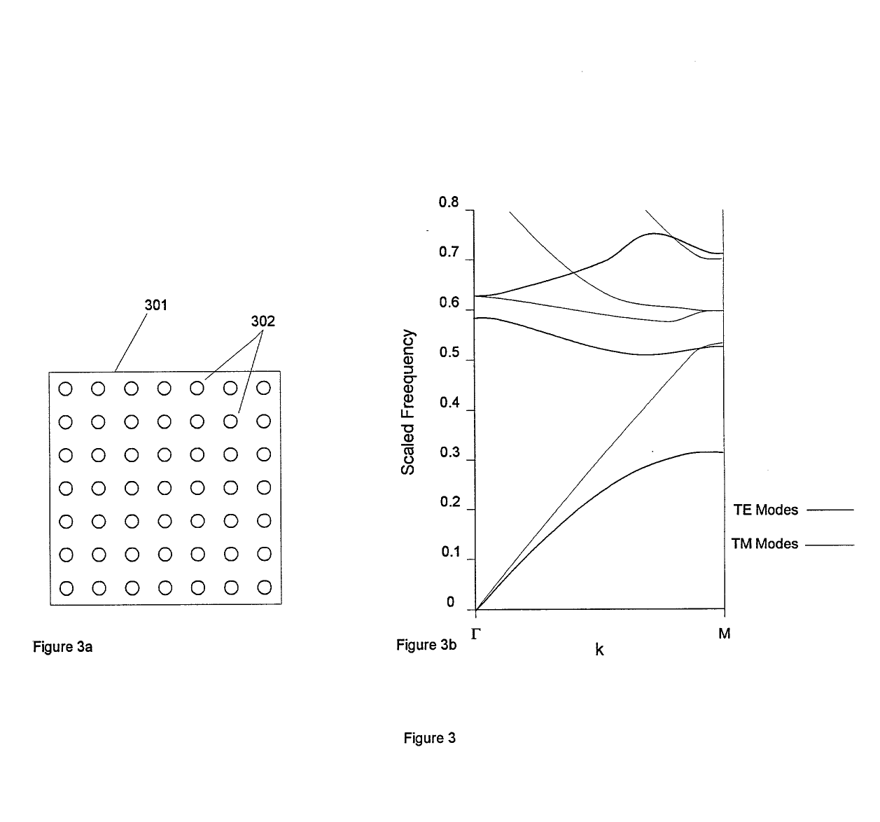

FIG. 3 shows FIG. 3a) the configuration of a square two-dimensional photonic crystal, and FIG. 3b) the corresponding photonic band structure.

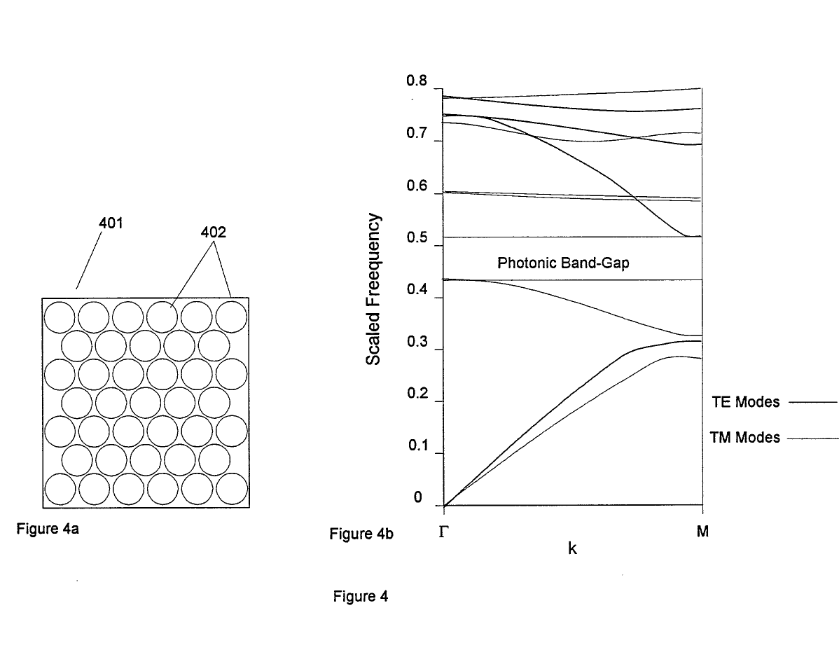

FIG. 4 shows FIG. 4a) the configuration of a triangular two-dimensional photonic crystal, and FIG. 4b) the corresponding photonic band structure.

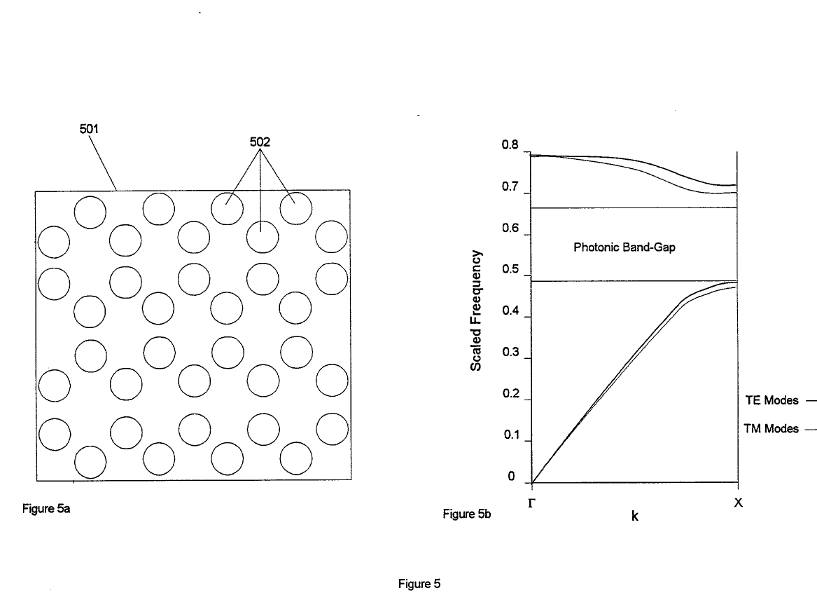

FIG. 5 shows FIG. 5a) the configuration of a diamond-lattice three-dimensional photonic crystal, and FIG. 5b) the corresponding photonic band structure.

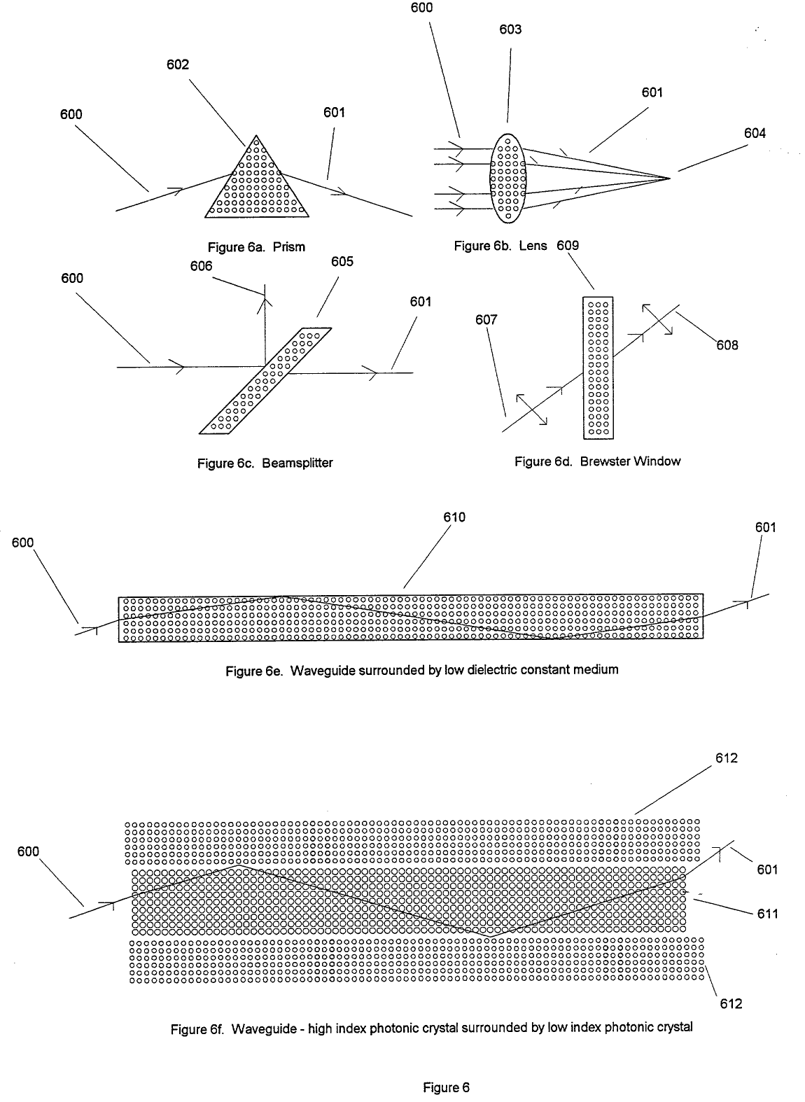

FIG. 6 shows schematic diagrams of a variety of optical elements based on the optical properties of photonic crystals.

FIG. 6a is a prism,

FIG. 6b is a lens,

FIG. 6c is a beamsplitter,

FIG. 6d is a Brewster window,

FIG. 6e is a waveguide, and

FIG. 6f is another implementation of a waveguide.

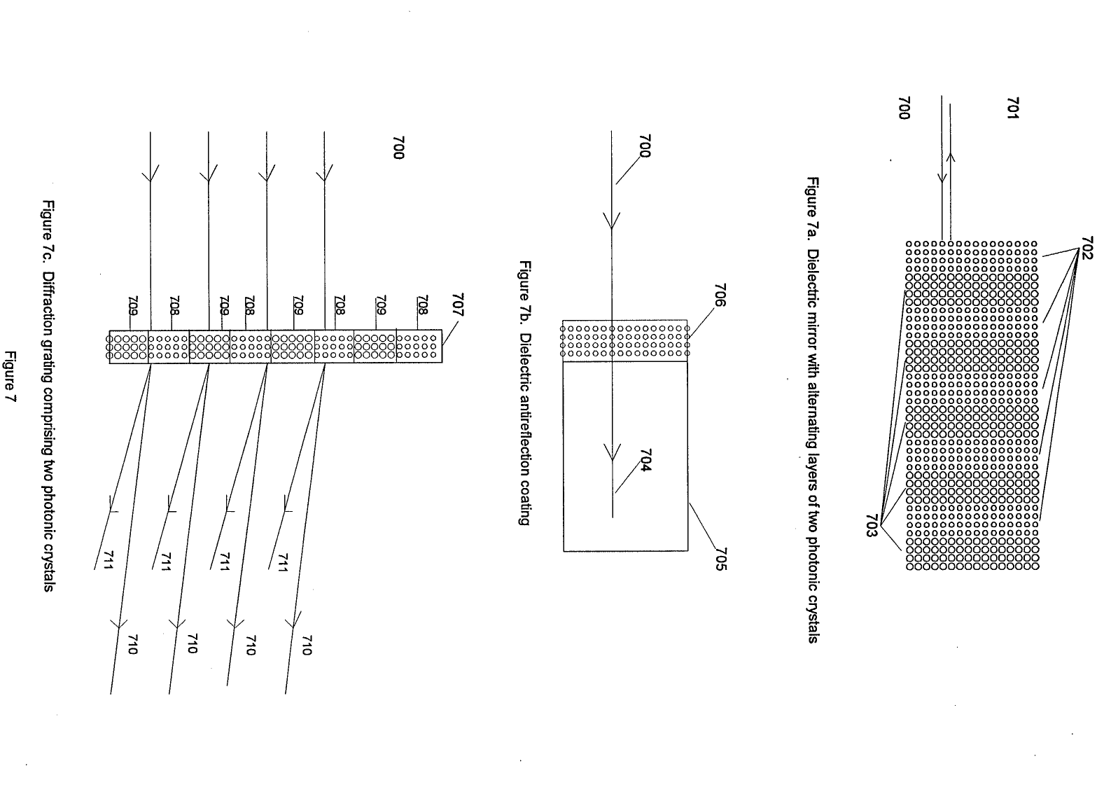

FIG. 7 shows schematic diagrams of dielectric and diffractive optical elements comprising photonic crystals.

FIG. 7a is a dielectric mirror,

FIG. 7b is a dielectric antireflection coating, and

FIG. 7c is a diffraction grating.

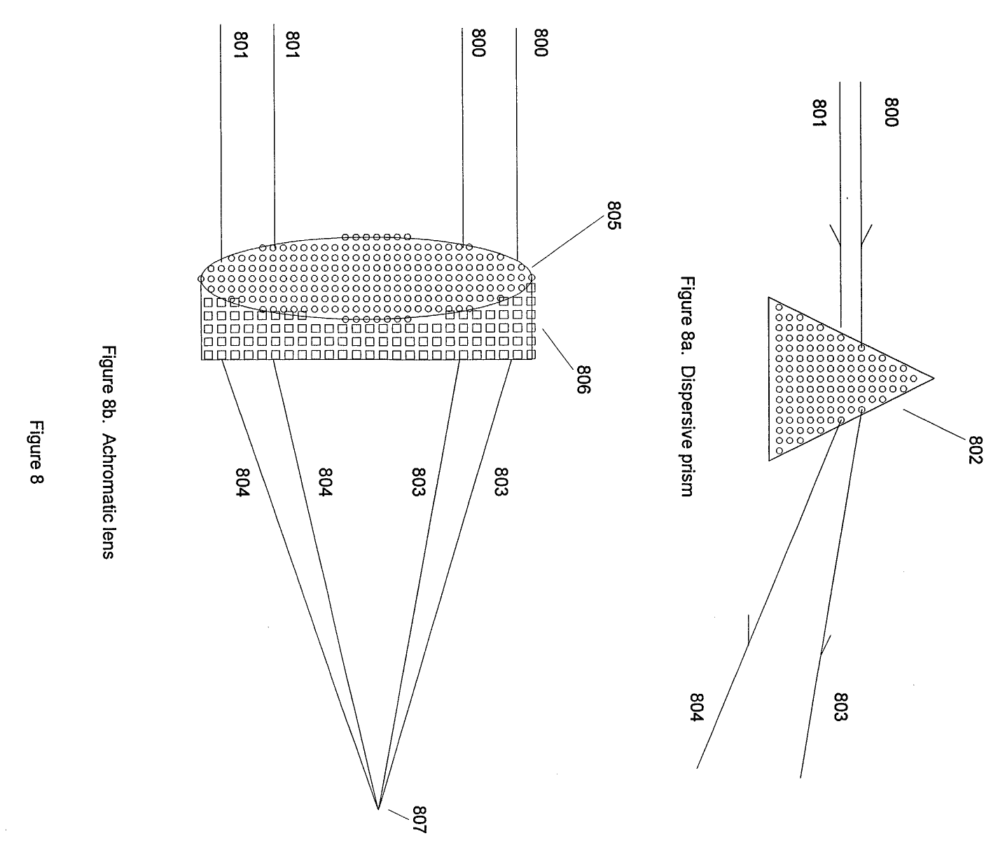

FIG. 8 shows schematic diagrams of optical elements comprising optically dispersive photonic crystals.

FIG. 8a shows a dispersive prism, and

FIG. 8b shows an achromatic lens.

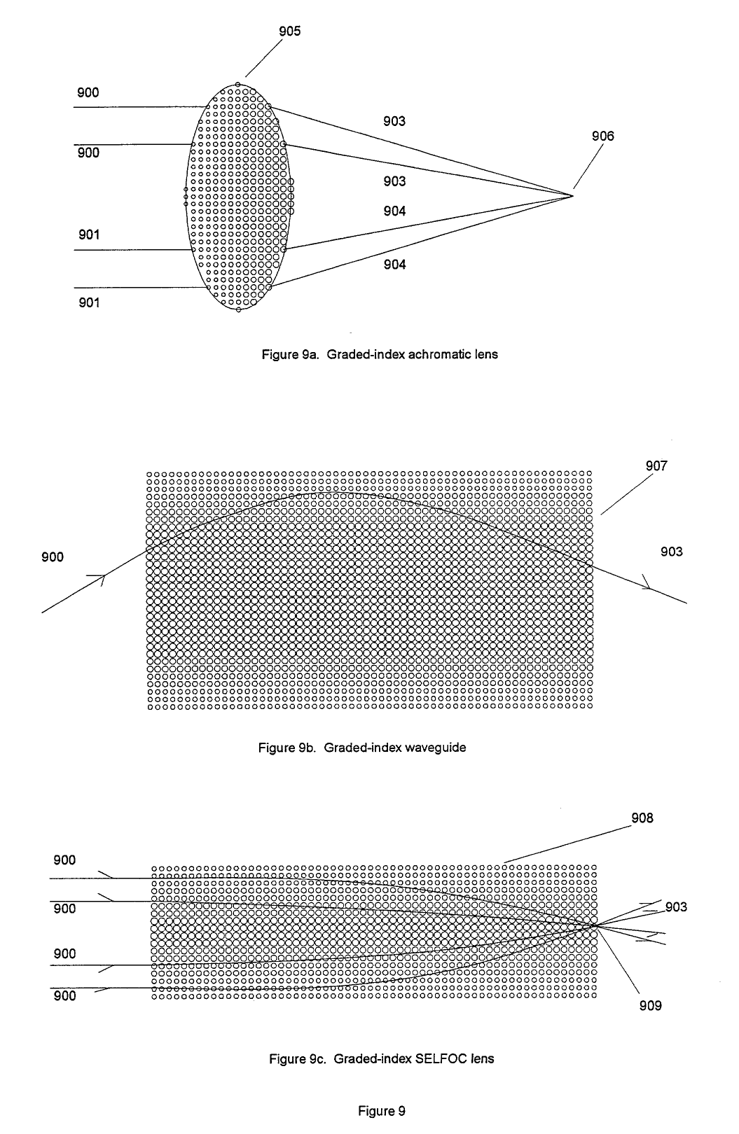

FIG. 9 shows schematic diagrams of optical elements comprising graded-index photonic crystals.

FIG. 9a is an achromatic lens,

FIG. 9b is a waveguide, and

FIG. 9c is a SELFOC lens.

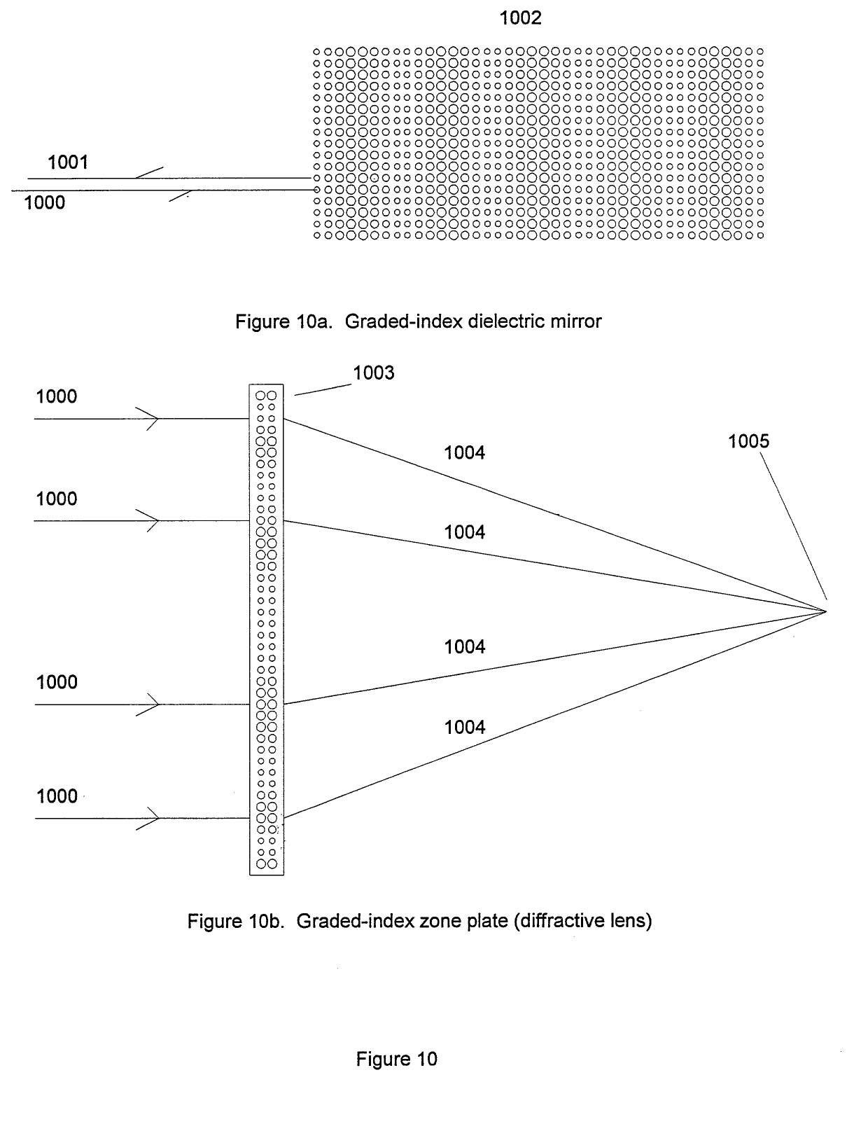

FIG. 10 shows schematic diagrams of dielectric and diffractive optical elements comprising graded-index photonic crystals.

FIG. 10a is a dielectric mirror, and

FIG. 10b is a zone plate.

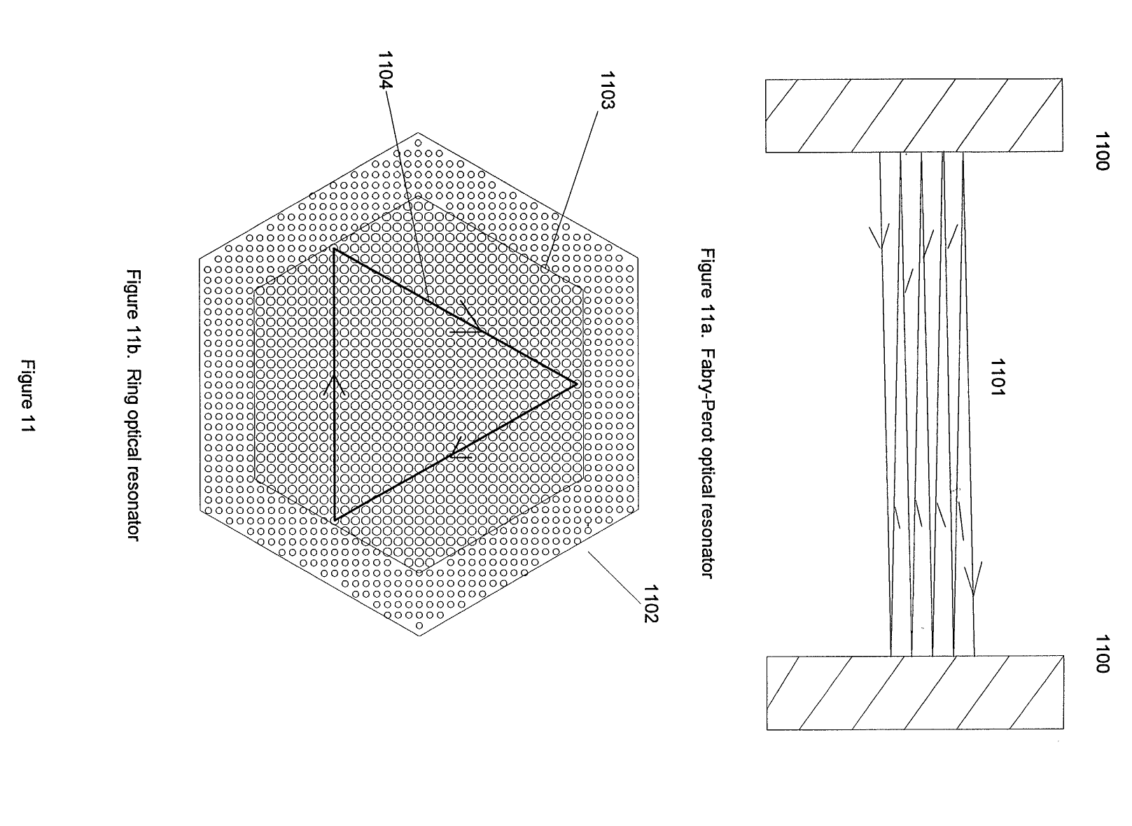

FIG. 11 shows schematic diagrams of optical resonators comprising photonic crystals.

FIG. 11a is a Fabry-Perot optical resonator using dielectric mirrors comprising photonic crystals, and

FIG. 11b is a ring optical resonator using total internal reflection.

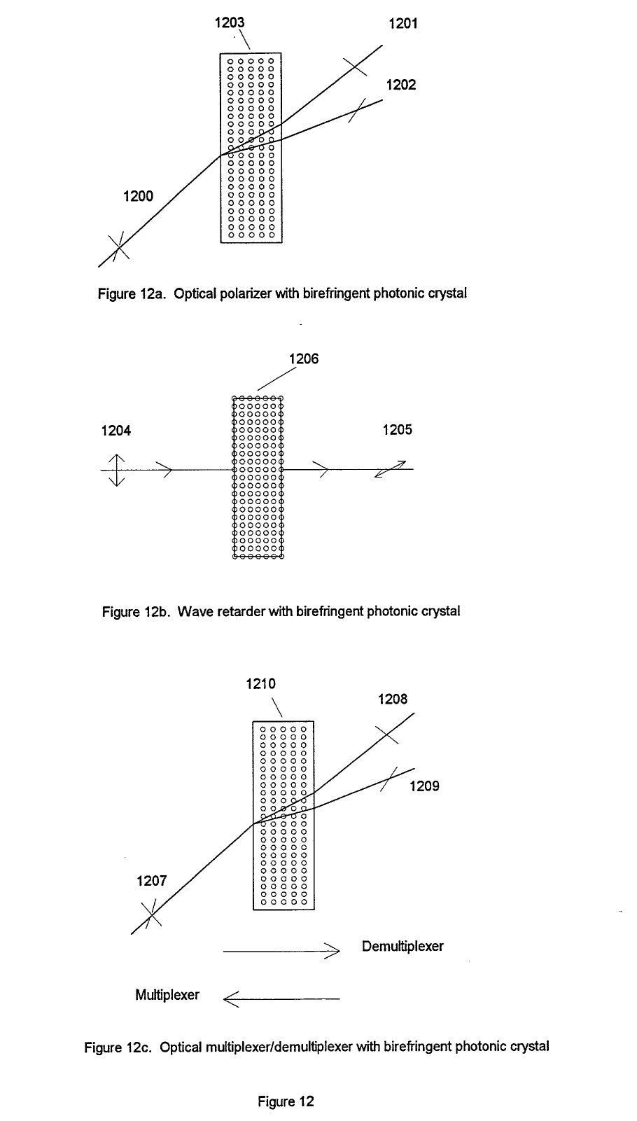

FIG. 12 shows schematic diagrams of polarizing optics comprising photonic crystals.

FIG. 12a is a polarizer,

FIG. 12b is a wave retarder, and

FIG. 12c is a multiplexer/demultiplexer.

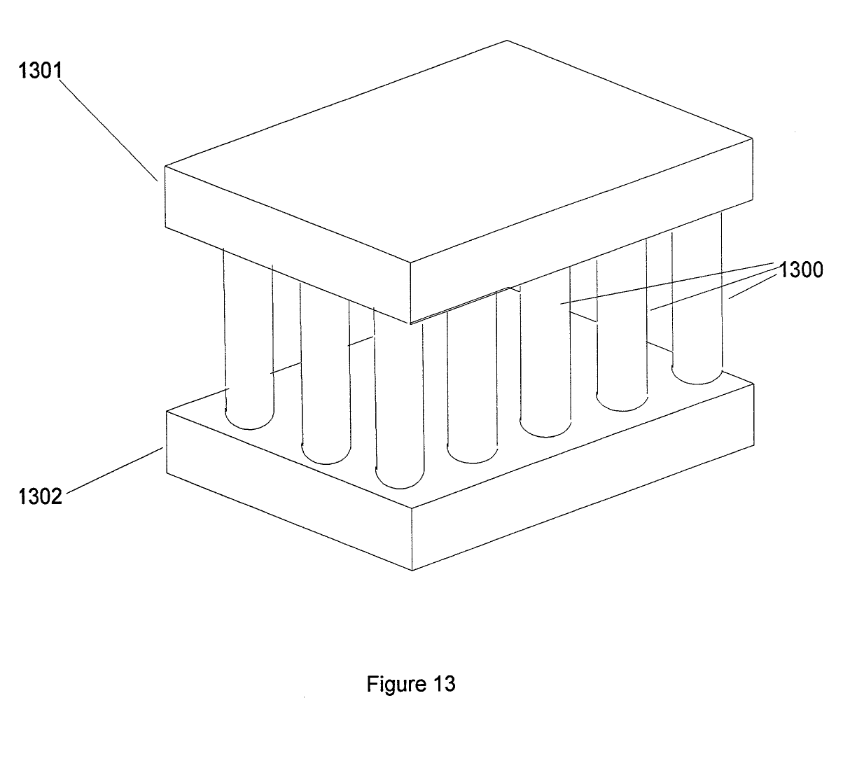

FIG. 13 shows a schematic diagram of a two-dimensional photonic crystal comprising a lattice of dielectric rods and top and bottom cladding layers.

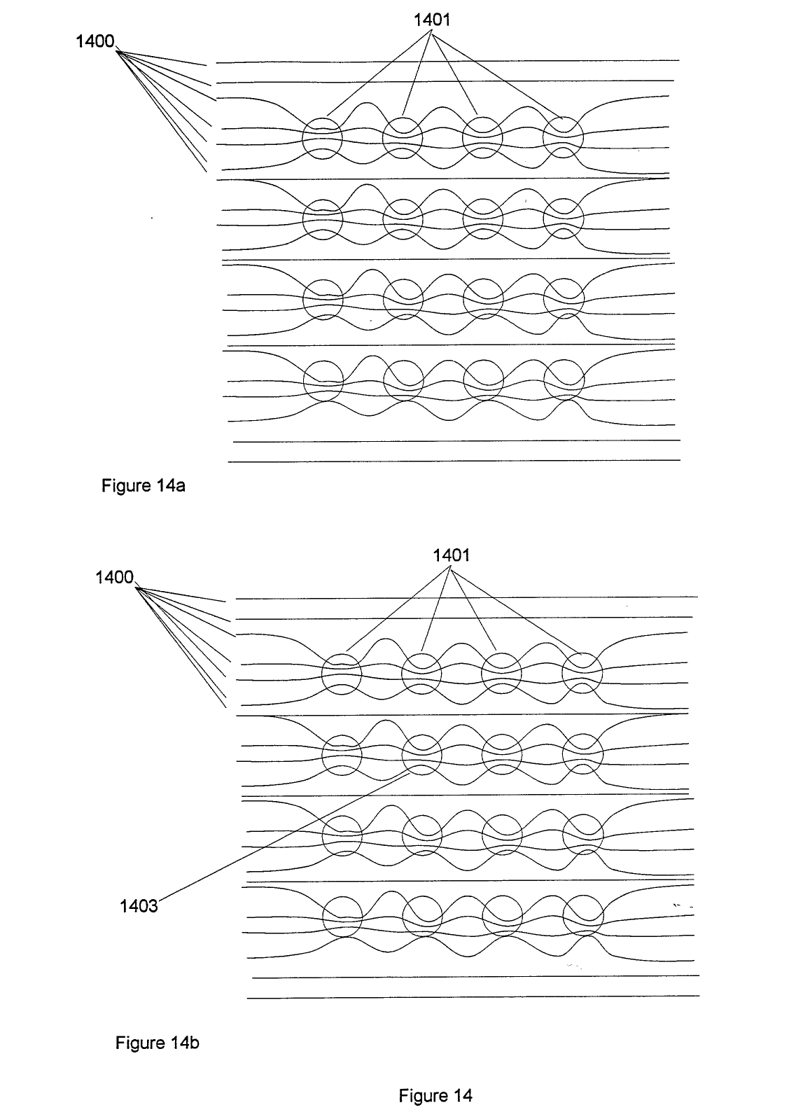

FIG. 14a shows how electromagnetic energy is concentrated in regions of high dielectric constant within a photonic crystal.

FIG. 14b shows how such concentration can be used to operate a device located within a photonic crystal.

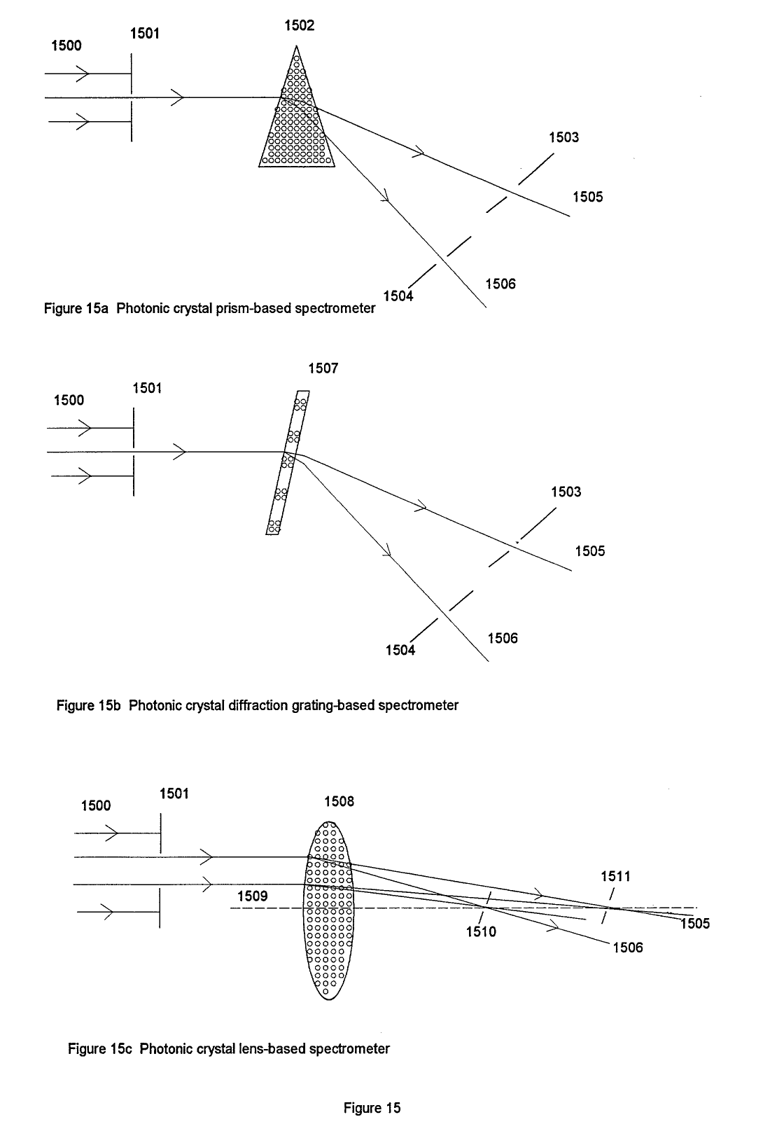

FIG. 15 shows schematic diagrams of spectrometer designs with optical elements comprising photonic crystals.

FIG. 15a shows a photonic crystal prism-based spectrometer,

FIG. 15b shows a photonic crystal diffraction grating-based spectrometer, and

FIG. 15c shows a photonic crystal lens-based spectrometer.

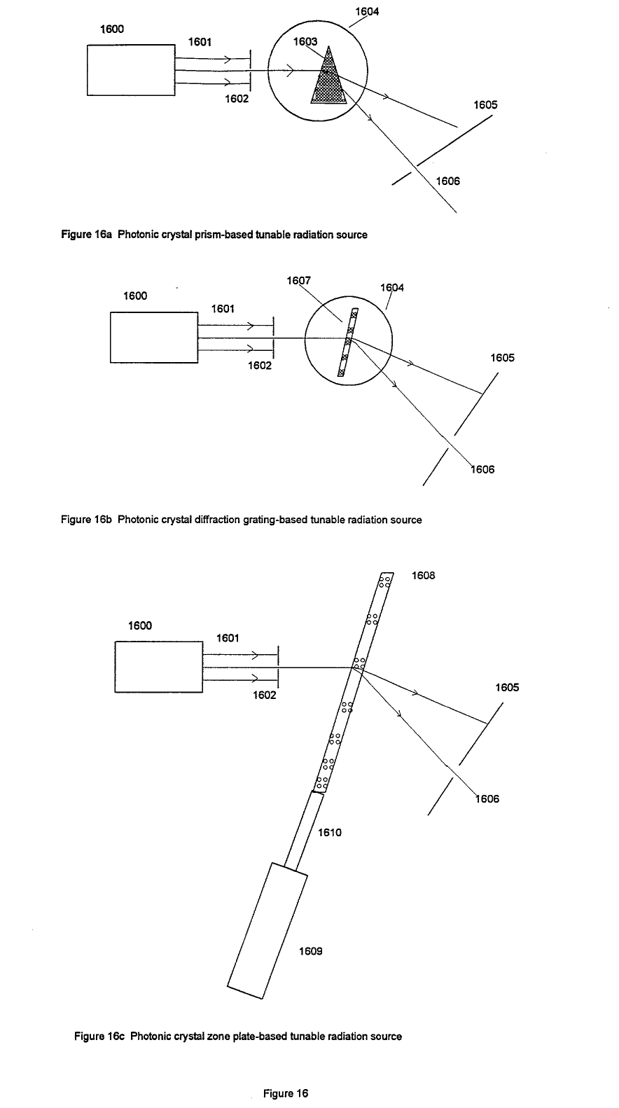

FIG. 16 shows schematic diagrams of tunable radiation sources comprising photonic crystals.

FIG. 16a uses a photonic crystal prism,

FIG. 16b uses a photonic crystal diffraction grating, and

FIG. 16c uses a photonic crystal zone plate to provide dispersion and separation of radiation of different frequencies.

### DETAILED DESCRIPTION

The general operating principles of optical elements whose function depends on the optical properties of photonic crystals outside any photonic band-gaps will be outlined below. This outline, together with general information about optics known to one skilled in the art, suffice to allow a practitioner to practice the present invention. However, illustration of these principles through examination of a number of specific implementations will prove useful. Such illustration is not intended to limit the scope of the invention, which is intended to be defined by the appended claims.

Consider a photonic crystal made up of two components, each having different dielectric constants. The effective dielectric constant of the photonic crystal for optical wavelengths which can propagate through the photonic crystal will be intermediate between those of the two components. Thus, a lattice composed of air (ε=1) and GaAs (ε=11.4) may, depending on its structure, exhibit an effective dielectric constant of 4 or less. This ability to control the dielectric constant as a function of local lattice structure enables design of a new class of optical elements, those based upon transmission of light through a photonic crystal. Previous devices comprising photonic crystals operated within the frequency range of the photonic band-gap, and were based on using the presence of a photonic band-gap to totally exclude light from that lattice.

The macroscopic dielectric constant of a photonic lattice will generally depend on the direction of propagation through the photonic crystal, i.e., the index of refraction is anisotropic. Such anisotropy limits performance or complicates design of some types of optical devices (e.g., small f-number lenses, where optical anisotropy is an additional source of aberration). However, such optics can beneficially use photonic crystals through proper design. In other cases, optical anisotropy may be an essential feature in implementing an optical device. Examples would include optical signal couplers and interconnects, where two optical signals incident on the surface of an anisotropic photonic crystal may be refracted into a common propagation direction.

Another highly important property of light propagating through a photonic crystal concerns highly non-linear macroscopic optical dispersion which appears near the edge of the bandgap. Note that this macroscopic near-bandgap dispersion need not reflect any variation in the microscopic index of the substance(s) from which the photonic crystal is made. The variation in the macroscopic index of refraction of a photonic crystal is primarily the effect of the spatially periodic variation of the microscopic index of refraction within the photonic crystal. This very strong dependence of dielectric constant, and hence index of refraction, on photon energy near the bandgap allows photonic crystals to be used to form highly dispersive prisms and other optical elements.

Photonic crystals need not possess a complete photonic band-gap to exhibit useful optical dispersion, birefringence, or anisotropy. The periodic structure of a photonic crystal imposes a particular property on the frequency versus wavevector behavior f(k); at high symmetry points (save when f(k)=0) f(k) satisfies ∇ₖf(k)=0, as illustrated in FIG. 1. FIG. 1a shows the photonic band structure for a uniform non-dispersive medium, where the angular frequency ω(k)=2πf(k) is plotted as a function of |k|. The constant slope of the band structure reflects the lack of dispersion. In contrast, FIG. 1b shows the photonic band structure for a photonic crystal where k(sym) is a low-order symmetry wavevector. As the index of refraction n(f) is related to f(k) by n(f)=c|k|/2πf, where c is the speed of light, the flattening of the band structure near the high symmetry points causes the dielectric constant to change, thereby introducing dispersion.

Note that the detailed structure of the photonic crystal can be chosen, using photonic band structure analysis as outlined below, so as to control the magnitude of optical dispersion, birefringence, and anisotropy exhibited by the photonic crystal. This includes cases in which these optical parameters can be made orders of magnitude stronger than appear in most conventional optical materials. A useful analogy to appreciate the level of control a practitioner has over the optical properties of photonic crystals is the precision design of semiconductor devices which use strained-layer construction and superlattices to tailor the electronic properties which define the device. Photonic crystals functioning outside photonic band-gaps allow an optical designer to use a created material having precisely chosen properties, rather than making do with the optical properties of those bulk materials which nature saw fit to supply us. The resulting flexibility in design and implementation of optical devices is enormous.

Although the above description is only strictly valid for infinite and perfectly periodic systems, the introduction of finite-size constraints and defects in the periodic structure of a photonic crystal has little effect on the optical properties on which the present invention depends. As long as the characteristic dimensions of the system in question are large compared to the optical wavelength being used (larger by an order of magnitude or more), the dispersive behavior characteristic of a photonic crystal appears. As long as the defect density does not disrupt the qualitative properties of the band structure, then the dispersive behavior characteristic of a photonic crystal appears. [An analogy from electronic band structure is simple window glass, an amorphous material which has an incredibly high defect density relative to any periodic structure, but which nonetheless possesses a well-defined electronic band-gap and dispersion similar to that of a crystal (save for being spatially isotropic).] For the purposes of this application we shall call any material having a spatially-varying microscopic dielectric constant which exhibits macroscopic optical properties which differ substantially from the microscopic optical properties of the material a photonic crystal.

Some materials qualifying as photonic crystals under the above definition will be described as having a given symmetry when the spatially-varying microscopic dielectric constant locally exhibits a consistent symmetry and orientation, even when the photonic crystal fails to obey the given symmetry globally (owing to, e.g., free surfaces and other local defects). As mentioned above, materials with spatially-varying microscopic dielectric constant which do not possess a given symmetry may still exhibit the properties characteristic of photonic crystals.

The vector nature of electromagnetic radiation tells us that two independent modes, having orthogonal polarization orientation, can exist for any given wavevector. An example of independent modes is the description of electromagnetic radiation in a two-dimensional photonic crystal as being a superposition of transverse-electric (TE) modes, where the magnetic field is normal to the symmetry plane, and transverse-magnetic (TM) modes, where the electric field is normal to the symmetry plane. Different modes propagating through a photonic crystal at the same frequency in the same direction will in general experience different dielectric constants (birefringence). Such polarization dependent effects, if large enough, may degrade the optical performance of some types of optical devices comprising photonic crystals (e.g., lenses intended to focus non-polarized light), but may be the basis for other types of optical devices (e.g., wave retarders).

Anisotropy, birefringence, and related behaviors occur in most photonic crystals, but these effects can be increased in magnitude by choosing periodic lattices having lower symmetry. For example, a square two-dimensional structure may be scaled in one direction, resulting in a rectangular structure if the scaling factor is applied parallel to one side of the square lattice, otherwise in a rhomboidal structure. A photonic crystal having a given symmetry constructed by rescaleing the dimensions of a highly symmetric lattice along one spatial direction will be called uniaxial, and it will exhibit uniaxial optical properties. A photonic crystal having a given symmetry constructed by rescaleing the dimensions of a highly symmetric lattice by different amounts along two orthogonal spatial directions will be called biaxial, and it will exhibit biaxial optical properties. Lattices based on such rescaleings of the face-centered cubic (fcc) structure are shown in FIG. 2.

A further aspect of photonic crystals is that the optical behavior scales as does the underlying dielectric structure. That is, if all the dimensions of a photonic crystal are doubled, the wavelengths of photons within the bandgap are also doubled, and the functional region for a dispersive element changes by a factor of two. Similarly, if the periodic dielectric constant ε[r] is multiplied by a factor of 1/m², the frequencies of the mode patterns increase by a factor of m. Because of these scaling behaviors, it is convenient to describe the band structure of photonic crystals using a scaled frequency ω, where ω=ωa/2πc, a is the lattice constant of the photonic crystal and c is the speed of light.

These scaling behaviors, combined with the photonic band structure calculations described below, allow photonic crystals to be designed and used as optically transparent and dispersive materials with electromagnetic radiation of any wavelength. Practical factors in implementation, however, restrict the useful range to wavelengths between microwaves and ultraviolet radiation. The terms “light” and “optical” in this application shall refer to electromagnetic radiation having wavelengths in the range ^{˜}30 cm (microwaves) to ^{˜}30 nanometers (ultraviolet) and material properties and devices for such radiation.

For microwave applications photonic crystals may be implemented by, for example, arranging a two-or three-dimensional periodic array of large dielectric-constant elements (e.g., alumina-ceramic rods or spheres) embedded within a medium of smaller dielectric constant (e.g., plastic foam). For IR, visible, and ultraviolet applications, implementation of photonic crystals may be carried out using conventional lithographic techniques (for example, using directional etching to drill a periodic array of holes in a GaAs substrate), or formation of a periodic self-assembling array of nanoscopic dielectric crystals. A wide range of designs and fabrication techniques are practical, and the above listing of certain possibilities is not intended to limit the scope of the present invention.

The challenges and opportunities presented by the optically dispersive, polarization-dependent, and anisotropic photonic band structure can be made clearer by considering some examples. FIG. 3a shows a two-dimensional square array of dielectric columns 302 surrounded by air 301, said columns having a microscopic dielectric constant ε=8.9 and circular cross-sections with a radius equal to 0.2 of the lattice spacing.

The corresponding band structure is shown in FIG. 3b, which is a graph of scaled frequency versus wavevector magnitude for photons propagating along the [11] lattice direction. The TE modes are shown by heavy lines, the TM modes by light lines. The first thing to note is that there are accessible modes at all frequencies—hence this structure does not exhibit a complete photonic band-gap. This lack of a complete photonic band-gap can at times be used to good benefit. For scaled frequencies between about 0.32 and 0.52, a photonic band-gap exists for the TM modes, while a similar gap appears only between 0.53 and 0.58 for the TE modes. This effect can be used to make polarizing filters which are frequency dependent, i.e., which only polarize light within a certain range of frequencies. Such devices are useful, e.g., in optical multiplexing.

At long wavelengths (i.e., near k=0) the TE and TM modes experience different macroscopic indices of refraction. (Recall that the index of refraction experienced by a mode is inversely proportional to the slope of the line connecting the mode and the origin.) The long wavelength macroscopic index of refraction for TM modes is approximately 1.5, even though the microscopic index of the material from which the photonic crystal is formed is approximately 3.0. In contrast, the low frequency macroscopic index for TE modes is only about 1.2. Hence, this photonic crystal is inherently strongly birefringent.

The square lattice described above shows particularly strong optical dispersion. The index of refraction at the TM band gap for propagation in the [11] direction is approximately 50% larger than it is at low frequencies (the maximum value of the TM mode macroscopic index of refraction below the TM bandgap is about 1.85). This change of index occurs primarily as the scaled wavelength increases from approximately 0.2 to 0.3. The size of the optical dispersion is larger than is characteristic of most conventional optical materials, and easily suffices to form the basis for optically-dispersive optical elements.

An example of a two-dimensional photonic crystal which does have a complete photonic band-gap is provided by a triangular lattice (the two-dimensional analog of the hexagonal close-packed structure) consisting of holes drilled in a high dielectric constant material surrounded by air (FIG. 4a). Specifically, when the dielectric constant of the high dielectric constant material 401 is 13, and the radius of the holes 402 is 0.48 of the lattice constant, a complete photonic band-gap appears for scaled frequencies between about 0.43 and 0.52, in which no modes propagate through the photonic lattice.

This photonic crystal exhibits the photonic band structure of FIG. 4b for propagation along the [10] direction. As in the square lattice example, the macroscopic index of refraction is much smaller than the microscopic index of refraction of the high dielectric constant material (about 3.6). In this direction, the long wavelength macroscopic index of refraction is about 1.56 for TM modes, and about 1.35 for TE modes. The magnitude of the optical dispersion is smaller than for the earlier example, but still more than sufficient to form the basis for optically dispersive optical devices. The maximum index of refraction in the [10] direction for the dielectric TM modes is 1.85, and that for the dielectric TE modes is 1.55, in both cases a 15-20% change in refractive index with frequency.

Photonic bandstructures have also been evaluated for three-dimensional photonic crystals (FIG. 5). A complete photonic band-gap is exhibited by a structure composed of air spheres 502 (ε=1) in a lattice of diamond symmetry embedded in a medium 501 of high dielectric constant (ε=13). The spheres have a radius of 0.325 of the lattice constant, and fill some 81% of the total volume of the photonic crystal. This example exhibits a complete photonic band-gap for scaled frequencies between about 0.5 and 0.66.

FIG. 5b shows the photonic band structure for this photonic crystal for propagation along the [100] direction. The macroscopic index of refraction is nearly independent of polarization below the bandgap, a feature approximately true for arbitrary propagation direction in this crystal. The macroscopic index of refraction in the [100] direction is about 1.5 for low frequencies, and about 2.1 just below the bandgap. This 40% change in refractive index is more than sufficient on which to base dispersive optical elements.

A second example of a three-dimensional photonic crystal is known as Yablonovite, which can be formed as follows. The top surface of a slab of dielectric material is covered by a mask consisting of a triangular array of holes. Each hole is drilled three times, at an angle of 35.26 degrees away from the normal to the top surface, and spread out 120 degrees azimuthially, such that this azimuthal orientation is constant at all holes. The result is a diamond-like lattice of dielectric veins which is particularly easy to fabricate over a wide range of lattice constant. The Yablonovite structure, however, is not a true diamond structure, having only a D_{3d} symmetry. This lowering of symmetry results in broken degeneracies in the band structure at some of the high-symmetry points of the Brillouin zone. This lower symmetry produces a much higher level of birefringence than is exhibited by the diamond lattice structure of FIG. 5.

Note that, although in the above examples the spatial variation in microscopic dielectric constant is discontinuous, and only two values of microscopic dielectric constant are used, these restrictions are not necessary to the design or implementation of photonic crystals. Continuous variations in microscopic dielectric constant and structures having microscopic dielectric constant with a number of distinct local maxima and minima are consistent with useful implementations of photonic crystals, as are spatially varying lattice constants, microscopic dielectric constants, and feature dimensions.

We see from the above examples that photonic crystal structures exist, in both two and three dimensions, which possess unusual and useful optical properties for light propagation outside the bandgap regions. Further, these unusual properties are of sufficient magnitude to be the basis for a class of optical devices whose function utilizes said properties.

A simple example is a prism. A prism based on photonic crystals can have a size of as little as 10-20 microns when designed for an operating wavelength in the neighborhood of 700 nanometers (red light). The functional bandwidth of this type of prism can be 25% or more of the center wavelength, so that the aforementioned prism can be functional between roughly 600 and 800 nanometers. Such prisms are suitable for use in spectrometers, tunable radiation sources, and other frequency-dependent optical and optoelectronic applications, and are of particular interest when they can be directly fabricated upon, e.g., a semiconductor integrated circuit.

A wide variety of optical elements can be constructed of photonic crystals, and used in applications involving electromagnetic radiation not excluded by a photonic band-gap. Several examples of optical elements based on photonic crystals appear in FIG. 6. FIG. 6a shows a prism 602 refracting an incoming light wave 600 into an exit light wave 601. The prism is made of a photonic crystal, here indicated schematically as a square array of dielectric rods, but which in fact may have any structure which yields optical properties suitable for the application. FIG. 6b shows a lens 603, which is made of a photonic crystal with a lenticular cross-section. FIG. 6c shows a beamsplitter 605, which is made of a plate of photonic crystal, and which splits the incoming light wave 600 into an exit light wave 601 and a reflected light wave 606. The types of devices shown in FIGS. 6a-c can also be implemented as prism, lens, or plate-shaped regions devoid of photonic crystal surrounded by photonic crystal, or by photonic crystal imbedded in an external dielectric medium having larger or smaller dielectric constant than does the photonic crystal making up the optical element. The design principles are the same in all these cases.

FIG. 6d shows a Brewster window consisting of a plate of photonic crystal 609. An incoming TM-polarized light wave 607, when incident on Brewster window 609 at Brewster's angle, is transmitted through the plate of photonic crystal as a TM-polarized exit light wave 608 with no reflective loss at the interfaces.

FIG. 6e shows a waveguide composed of a rod 610 of photonic crystal surrounded by a medium (not shown) having a dielectric constant less than that of the photonic crystal. Light 600 incident on the rod is trapped inside the rod by total internal reflection at the interface between the rod and the surrounding medium until it escapes from the opposing end of the rod as exit light wave 601. Such total internal reflection will occur when the surrounding medium has a lower dielectric constant than the rod—this is illustrated in FIG. 6f where a rod 611 of photonic crystal with a large dielectric constant is surrounded by a region 612 filled with a photonic crystal having a smaller dielectric constant. Note that the natural birefringence of most photonic crystals can be used to make such waveguides serve as polarization-maintaining waveguides; that is, to reduce the coupling between different modes so as to limit power transfer between modes.

The schematic diagram in FIG. 6f suggests the difference in optical properties of the two photonic crystals by using larger circles in the higher index material. If one thinks of the circles as regions of high dielectric constant material embedded in a medium having lower dielectric constant, then, given constant symmetry and lattice parameter, the macroscopic dielectric constant will increase as the radius of the high dielectric constant regions (the circles) increases. Note that the symmetry and lattice parameter need not be held constant to obtain a change in dielectric constant; it is merely how the schematic drawings can be easily understood. This meaning of the schematic drawing of photonic crystal shall be used throughout this application.

The difference in macroscopic dielectric constant and other optical properties which may be exhibited by different photonic crystals can be used to implement a wide range of dielectric and diffractive optical elements. Examples of dielectric optical elements would include antireflection coatings and dielectric mirrors, in which optical materials having different indices of refraction are combined in a manner known to one skilled in the art to produce the desired overall optical behavior. Some or all of the optical materials used in implementing such devices may comprise photonic crystals.

Diffractive optical elements use interference of light which travels on multiple paths to reach a given point to produce a desired optical behavior. Typical diffractive elements include diffraction gratings and zone plates. The design of such diffractive elements is well known to one skilled in the art. The source of diffraction can be local variations in transparency or local variations in refractive index. Diffractive optical elements based on this latter principle can be implemented using photonic crystals as part or all of their structure.

Such optical elements are illustrated schematically in FIG. 7. 7a shows a dielectric mirror composed of alternating layers of two different photonic crystals 702 and 703. As before, the different indices of refraction of the two photonic crystals is indicated by the difference in the circle diameter. The resulting mirror exhibits nearly complete reflection 701 of incoming light wave 700 (incoming light wave 700 has a wavelength equal to the design wavelength of the dielectric mirror).

FIG. 7b shows an antireflection coating 706 on a conventional optical element 705, the coating consisting of a photonic crystal. The action of the antireflection coating is to reduce the reflection of incoming light wave 700 from the coated surface of the optical element 705.

FIG. 7c shows a diffraction grating 707 composed of alternating regions of two different photonic crystals 708 and 709. In this case, the incoming light wave 700 consists of light at two wavelengths, and the diffraction grating serves to separate 700 into two exit light waves 710 and 711, one wave at each of the incoming light wave's wavelengths.

Certain classes of optical elements depend not only upon an optical medium with a particular index of refraction for their functionality, but the optical material must also exhibit dispersion, i.e., a wavelength-dependent index of refraction. As described earlier, photonic crystals can exhibit significant dispersion over large wavelength ranges. Dispersive optical elements may thus comprise such dispersive photonic crystals beneficially.

Examples of such dispersive optics are shown schematically in FIG. 8. FIG. 8a shows a dispersive prism 802 made of a photonic crystal. There is an incoming light wave of a first wavelength 800 and an incoming light wave of a second wavelength 801 incident on the prism. The optical dispersion of the photonic crystal from which prism 802 is made refracts the two incoming waves into an exit light wave of a first wavelength 803 and an exit light wave of a second wavelength 804 such that the two exit waves are no longer parallel. Such dispersion forms the basis for numerous classes of optical devices, such as spectrometers and monochromators.

The optical dispersion which is of benefit in the above case can impair the performance of other optical elements. An example would be a simple lens composed of optically dispersive material, which will have different focal lengths for different wavelengths of light. Although such effects can be applied (in the above example the dispersive lens may be used as the wavelength-separating element in a spectrograph), in other cases the resulting chromatic aberration is not tolerable.

Chromatic aberration in a lens can be reduced by combining the optical effect of multiple lenses made from optical media having different properties. A common example is a common achromatic lens, in which a positive lens of a first optical medium and a negative lens of a second optical medium are combined in a manner known to one skilled in the art to produce a composite lens which brings light of two different wavelengths (called coincident design wavelengths) to a common focus. Such a lens generally exhibits reduced chromatic aberration over a range of wavelengths which includes the two coincident design wavelengths, and is called achromatic, although some level of chromatic aberration is still apparent. Related systems include composite lenses comprising many individual lenses whose individual optical properties are combined to result in a desired overall optical effect, and such devices as achromatic prisms, where multiple prisms composed of optical media having different properties are combined to provide (nearly) uniform deviation of incoming light waves over a range of wavelengths. Any of the achromatic optical elements described above can beneficially comprise photonic crystals.

FIG. 8b shows the example of a simple achromatic lens comprising a pair of lenses 805 and 806, which are formed of two different photonic crystals having differing optical dispersion. The design of the lenses to achieve the desired achromatic behavior depends on the properties of the two different photonic crystals in a manner known to one skilled in the art. Incoming light wave 800 of a first wavelength is diverted by the combined effect of lenses 805 and 806 into the converging light wave 803, which comes to a focus at focal point 807. Incoming light wave 801 of a second wavelength is diverted by the combined effect of lenses 805 and 806 into the converging light wave 804, which also comes to a focus at focal point 807, thereby implementing the desired achromatic lens function.

Designing an achromatic lens is only one example of how optical elements made of different optical media may be combined to reduce aberrations. An excellent example is a zoom camera lens, where the effects of perhaps 20 individual lenses will be combined to reduce to tolerable levels chromatic aberration, spherical aberration, field curvature, and other aberrations while allowing the composite lens to achieve parfocal behavior for a 10-to-1 range of effective focal lengths. The unusual and uniquely controllable optical properties of photonic crystals can be used to greatly simplify many such composite optical elements.

A graded-index optical material has a refractive index which varies with position in accordance with a smooth function n(r), where r is position within the material. In a graded-index optical medium, light rays travel along curved paths instead of straight lines. By appropriate choice of n(r) and shape of the medium, the function of a conventional lens or other optical element can be reproduced, using techniques and principles known to one skilled in the art.

Photonic crystals can be used to make a graded-index optical material in numerous ways, including:

1) varying size of the lattice elements of the photonic crystal as a function of position over the optical element while keeping the symmetry, lattice parameter, and microscopic refractive index constant;

2) varying magnitude of the microscopic index of refraction of the photonic crystal as a function of position over the optical element while keeping the symmetry, lattice parameter, and lattice element geometry constant;

3) varying lattice parameter of the photonic crystal as a function of position over the optical element while keeping the symmetry, lattice element geometry, and microscopic refractive index constant;

4) varying the symmetry of the photonic crystal as a function of position over the optical element while keeping the lattice element geometry, lattice parameter, and microscopic refractive index constant;

5) combinations of the above procedures.

The only absolute requirement to implement a graded-index optical material using photonic crystals is that the optical properties change with position, and thus the structure or composition of the photonic crystal must change with position, forming an optical material we call a spatially-varying photonic crystal.

Graded-index optical materials based on spatially-varying photonic crystals can be beneficially used to implement any form of graded-index optical element. Some examples appear in FIGS. 9 and 10. In these figures the spatial variation of the structure of the photonic crystal is suggested schematically by the changing the size of the circles with position. Neither the pattern of spatial variation nor the magnitude of the changes in size is intended to communicate a particular design choice—the design of graded-index optical elements is known to one skilled in the art, and we reveal earlier how to evaluate the optical properties of photonic crystals on which those designs will be based.

FIG. 9a shows an achromatic lens, where the composite lens of FIG. 8b is replaced by a single optical element composed of a photonic crystal with a spatially-varying structure. Again, the effect is to focus incoming light waves 900 and 901 of different wavelengths onto a single focal point 906.

FIG. 9b shows a graded-index waveguide, in which the waveguide 907 is composed of a spatially-varying photonic crystal which has a high index of refraction in the central region and decreasing index on approaching the edge (again, this change is suggested by the change in the size of the circles). Such graded-index waveguides significantly reduce the pulse spreading caused by the differences in group velocities of the modes of a multimode waveguide. The result is less distortion of signals transmitted over a distance via waveguide. Note that, just as in the earlier case of step-index waveguides (FIG. 6e and FIG. 6f), the natural birefringence of most photonic crystals can be used to make a graded-index waveguide serve as a polarization-maintaining waveguide.

An interesting subclass of graded-index waveguides can be used as the functional equivalent of lenses. Such an element is shown in FIG. 9c. If the graded-index optical element 908 has a parabolic variation in macroscopic dielectric constant about the central axis, it will serve to bring incident light 900 to a common focus 909. The equivalent focal length depends on the magnitude of the parabolic variation in a manner known to one skilled in the art. This structure can be implemented using photonic crystals by introducing a radial variation in, e.g., the size of the dielectric elements which make up the photonic crystal. If the desired parabolic variation is small, the change in element size will depend roughly linearly on radial position. However, if the desired parabolic variation is large, the change in element size will be more complex, but still calculable using the band-structure techniques described earlier.

FIG. 10 shows how spatially-varying photonic crystals can be used to form dielectric and diffractive graded-index optical elements. The design principles are essentially the same as described earlier, save that abrupt changes in macroscopic refractive index with position are replaced by gradual changes. FIG. 10a shows a graded-index dielectric mirror 1002 made of a spatially-varying photonic crystal, and FIG. 10b shows a zone plate which acts as a diffractive lens made of a spatially-varying photonic crystal.

An optical resonator, the optical analog of an electronic resonant circuit, confines and stores light at certain resonance frequencies which are determined by the size of the resonator. Photonic crystal optical elements can be beneficially used to implement a wide variety of optical resonator designs. Two specific examples are shown in FIG. 11 to demonstrate the principles of such implementation.

In FIG. 11a appears in schematic form a Fabry-Perot optical resonator, which consists of two parallel, highly reflective mirrors 1100 separated by a distance. To make such a resonator using photonic crystals, one simply replaces the mirrors 1100 with photonic crystal-based dielectric mirrors as described earlier (FIG. 7a and FIG. 10a).

FIG. 11b shows a ring resonator implemented using photonic crystals using a different approach. A hexagonal region 1103 of photonic crystal of a given index of refraction is surrounded with another optical medium 1102 (here a second photonic crystal) having a smaller index of refraction. The ratio of the indices of refraction is large enough that light propagating along path 1104 (and similar paths) undergo total internal reflection at the interface between 1103 and 1102. This design takes advantage of the tremendous variations in index of refraction which result from simple changes in the structure of a photonic crystal.

The role of the natural birefringence exhibited by most photonic crystals has been mentioned briefly in the context of making polarization-maintaining waveguides. Such birefringence makes possible a whole class of optical elements which interact with the polarization of an incident light wave.

Examples appear in FIG. 12. FIG. 12a shows an optical polarizer based on refraction of an incident wave 1200 through a birefringent photonic crystal 1203. The two polarization components of 1200 experience different indices of refraction at the interfaces with the surrounding medium, and hence refract through different angles. The result is to separate the incident wave 1200 into two waves 1201 and 1202 having different polarization characteristics. This type of polarization can also be carried out using various prism-based polarizers known to one skilled in the art.

A similar effect is used in the element shown in FIG. 12b to retard an incident linearly polarized light wave 1204. A birefringent material has a fast and a slow, axis along which the normal modes of the material are polarized. Birefringent photonic crystal 1206 is oriented so that the incident light 1204 is propagating along the direction of the normal modes of 1206, but the polarization of 1204 is not parallel to those of the normal modes. When incident light wave 1204 enters the birefringent element 1206, it is split into the two normal modes of 1206. As these normal modes propagate with different speeds, however, they experience a relative phase shift which varies linearly with distance propagated in 1206. If the total phase shift is 2nπ+π/2, the element is called a quarter-wave retarder, and will convert the linearly polarized incident light wave 1204 into elliptically polarized light. If the total phase shift is (2n+1)π, the element is a half-wave retarder, and will rotate the plane of polarization 90 degrees, so that the incident wave 1204 and the exit wave 1205 have orthogonal polarization. Such elements may be implemented using any photonic crystal which exhibits birefringence in the desired operational wavelength region.

In FIG. 12c the use of an optical polarizer of the type described in FIG. 12a to combine or separate two optical signals having orthogonal polarizations is illustrated. Such multiplexing/demultiplexing elements allow the data-carrying capacity of an optical data link to be doubled.

A particular concern to certain applications of two-dimensional photonic crystals is the behavior of modes which do not propagate in the plane of periodicity. Analysis shows that the photonic band structure in the plane of periodicity remains approximately correct for modes propagating at a small angle to the plane of periodicity, but diverges strongly as ω approaches ck_{z}, where k_{z} is the magnitude of the wavevector perpendicular to the plane of symmetry. However, even for modes propagating at small angles to the plane of symmetry, difficulties may arise in retaining such modes within the photonic crystal. Consider a photonic crystal made by assembling a triangular array of dielectric rods having a length to diameter ratio of 5. Such a photonic crystal is shown in FIG. 13. Clearly, any mode propagating at an angle to the symmetry plane will shortly escape the photonic crystal, and in so doing will not only leave the system, but will not experience the full influence of the symmetry of the photonic crystal, thus again degrading the photonic band structure observed for modes propagating along the plane of symmetry.

One approach toward confining near-symmetry-plane modes to the physical extent of the photonic crystal is to clad the array of dielectric rods 1300 with top and bottom cladding layers 1301 and 1302. If these cladding layers have smaller macroscopic index of refraction than does the photonic crystal, light obliquely incident on the cladding layers will be totally reflected back into the photonic crystal.

The low-energy modes of a photonic crystal are characterized by concentration of the optical energy contained in the photonic crystal within the large-dielectric constant regions of the photonic crystal. This is illustrated schematically in FIG. 14a, in which the electric field lines 1400 are distorted by their interaction with the photonic crystal so as to form regions of high field density (and hence high energy density) within the large-dielectric constant regions 1401.

As much as 90% of the optical energy impinging on a two-dimensional photonic crystal can be concentrated in the large-dielectric constant regions—where the volume of the large-dielectric constant regions may only make up 15-20% of the total volume. Since the photonic crystal also stores a considerable amount of optical energy as a result of the multiple interference events which produce the characteristic optical—properties, the optical energy density inside the large-dielectric constant regions of the photonic crystal may be an order of magnitude or more larger than that of the light incident on the photonic crystal.

Now consider the situation shown in FIG. 14b, where an active optical device 1403 is included as part of the photonic crystal. The easiest case to imagine is where the photonic crystal is a two-dimensional array of rods, and one of the rods (1403) is a vertical-emitting laser. The effect of the photonic crystal is to increase the effect of the pump light by perhaps two orders of magnitude (taking into account that much of the pump light will, in the absence of the photonic crystal, reflect from the high-dielectric constant material from which the laser is formed. This also provides a mechanism to transmit information from a two-dimensional optical system perpendicular to the plane—a function possibly useful for optical interconnection.

This effect of energy concentration may also be used if 1403 is a photodiode, in which case the sensitivity of the device to external signals is increased, or if 1403 is a nonlinear optical element, for which the threshold for nonlinear operation is thereby reduced.

Photonic crystals offer numerous avenues toward implementation of a spectrometer, an apparatus which separates incident light into its spectral components. Several possible implementations are shown in FIG. 15. FIG. 15a shows a prism-based spectrometer in which incident light 1500 is collimated by collimator 1501, and then is directed onto prism 1502, which comprises optically dispersive photonic crystal. The incident light is thereby split into spectral components 1504 and 1505 which propagate in different directions, and which may be isolated from each other by slits 1503 and 1504 or other suitable devices.

A related spectrometer is shown in FIG. 15c, where the optically dispersive element is a lens 1508, which comprises optically dispersive photonic crystal. Lens 1508 focuses incident light 1500 at different focal points (e.g., 1510 and 1511) depending on the wavelength of the light. The spectrally dispersed light comes to a line focus on the symmetry axis 1509 of lens 1508, and may be collected for further processing there.

It is not necessary to use optically dispersive photonic crystals to make a spectrometer. This is illustrated in FIG. 15b, where a spatially-dispersed photonic crystal is used to implement a diffraction grating 1507. The diffraction grating disperses the incident light in a manner analogous to prism 1502, and the function of the spectrometer is identical to that of FIG. 15a.

One may combine a spectrometer with a broadband radiation source to form a nearly monochromatic radiation source. Such apparatus are shown in FIG. 16, where a broadband radiation source 1600 is combined with the spectrometer designs of FIGS. 15a and 15b to form prism and diffraction grating-based radiation sources. These radiation sources may be rendered tunable by inclusion of a pivoting mounting 1604 for the dispersive optical elements (prism 1603 and diffraction grating 1607). Although an exit wave with a single output wavelength 1606 is selected by slit 1605, multiple slits may be used to provide multiple nearly monochromatic outputs.

FIG. 16c shows another approach to the implementation of a tunable radiation source. In this case the optically dispersive element is a zone plate 1608 comprising photonic crystal, whose function is to disperse incident light of different wavelengths and, when moved along the long axis of the zone plate by moving means 1609 by connection means 1610, to change the angle of diffraction of the incident light. The net effect is that moving the zone plate changes the output wavelength 1606.

Suitable broadband sources 1600 for such radiation sources would include plasma sources for ultraviolet sources, incandescent lamps for visible and IR radiation, and ultrafast optoelectronic switches for far-IR and millimeter-wave applications. This listing is not intended to preclude the use of any other suitable broadband source.

The examples of optical elements comprising photonic crystals described above are for purposes of illustration only, and are not intended to limit the scope of the present invention. That scope is defined only by the claims appended.

1. An optical element which processes optical signals within a working frequency range, comprising a photonic crystal such that the optical signals are not excluded from the photonic crystal by photonic band-gaps.

2. The optical element of claim 1, where the optical element is chosen from the group consisting of a prism, a lens, a mirror, a Brewster window, a beamsplitter, a waveguide, a dielectric optical element, a diffractive optical element, an optical resonator, and an antireflection coating.

3. The optical element of claim 1, where the photonic crystal exhibits non-zero dispersion within the working frequency range.

4. The optical element of claim 3, where the optical element is chosen from the group consisting of a prism and an achromatic lens.

5. The optical element of claim 1, where the photonic crystal forms a graded-index optical material.

6. The optical element of claim 5, where the graded-index optical material forms an optical component selected from the group consisting of an achromatic lens, a graded-index waveguide, an optical coupler, a SELFOC lens, a dielectric optical element, and a diffractive optical element.

7. The optical element of claim 1, where the photonic crystal exhibits macroscopic birefringence in the working frequency range.

8. The optical element of claim 7, where the optical element is chosen from the group consisting of an optical polarizer, a wave retarder, an optical multiplexer, and an optical demultiplexer.

9. The optical element of claim 1, wherein the photonic crystal has a complete band gap.

10. The optical element of claim 1, wherein the photonic crystal is two-dimensional.

11. The optical element of claim 10, wherein the two-dimensional photonic crystal comprises a substantially periodic two-dimensional array of parallel rods with a first dielectric constant surrounded by a medium having a second dielectric constant.

12. The optical element of claim 1, wherein the photonic crystal is three-dimensional.

13. The optical element of claim 12, wherein the three-dimensional photonic crystal comprises a substantially periodic three-dimensional array of spheres with a first dielectric constant surrounded by a medium having a second dielectric constant.

14. The optical element of claim 1, wherein the photonic crystal has uniaxial optical properties.

15. The optical element of claim 12, wherein the three-dimensional photonic crystal has biaxial optical properties.

16. An apparatus to process optical signals in a working frequency range, comprising an optical element comprising a photonic crystal such that the optical signals are not excluded from the photonic crystal by photonic band-gaps.

17. The apparatus of claim 16, comprising a laser comprising a lasing medium within an optical resonator and an optical pumping source, said lasing medium being positioned within the photonic crystal so that light from the optical pumping source is concentrated within the lasing medium.

18. The apparatus of claim 16, comprising a photodetector positioned within the photonic crystal so that the optical signals are concentrated within the photodetector.

19. The apparatus of claim 16, comprising a nonlinear optical medium positioned within the photonic crystal so that the optical signals are concentrated within the nonlinear optical medium.

20. The apparatus of claim 16, further comprising a spectrometer, wherein the optical element separates optical signals of different wavelengths.

21. The apparatus of claim 20, wherein the optical element comprises a diffraction grating.

22. The apparatus of claim 20, wherein the photonic crystal is optically dispersive in the working frequency range.

23. The apparatus of claim 22, wherein the optical element is chosen from the group consisting of a prism and a lens.

24. The apparatus of claim 16, comprising a broadband source supplying broadband radiation and a monochromator which converts the broadband radiation to at least one substantially monochromatic output signal, said monochromator comprising the optical element.

25. The apparatus of claim 24, where the optical element is a diffractive optical element.

26. The apparatus of claim 24, where the photonic crystal is optically dispersive in the working frequency range and the optical element is chosen from the group consisting of a prism and a lens.

27. The apparatus of claim 24, where the broadband source comprises an optoelectronic switch.

28. The apparatus of claim 24, wherein the monochromator comprises a tuning mechanism to tune the at least one substantially monochromatic output signal over a substantial range of wavelengths.

29. The apparatus of claim 28, where the tuning mechanism comprises means to rotate the optical element.
